(19) United States
(12) Patent Application Publication
(10) Pub. No.: US 2026/0262709 A1
(43) Pub. Date: Sep. 10, 2026

(54) MANUFACTURING MACHINE FOR ROD USED IN FLAVOR INHALER AND MANUFACTURING METHOD FOR ROD

(71) Applicant: JAPAN TOBACCO INC., Tokyo (JP)

(72) Inventor: Takuya AKAHANE, Tokyo (JP)

(73) Assignee: JAPAN TOBACCO INC., Tokyo (JP)

(21) Appl. No.: 19/489,271

(22) PCT Filed: Jun. 23, 2023
(86) PCT No.: PCT/JP2023/023285

§ 371 Date: Dec. 2, 2025

(51) Int. Cl. A24D 3/02; A24C 5/01; A24C 5/18; A24C 5/28; A24D 3/17

(52) U.S. Cl. CPC A24D 3/0204; A24C 5/01; A24C 5/1892; A24C 5/28; A24D 3/0229; A24D 3/0254; A24D 3/17

(57) ABSTRACT

A manufacturing machine for producing a rod used in a flavor inhaler includes rollers that feed a sheet from a roll to a conveying path and additional rollers that crimp the sheet. A sensor detects a diameter of the roll, and control circuitry adjusts a crimping parameter based on the detected diameter. A trumpet guide and tong gather the crimped sheet in a width direction to form a bundled rod, which is then wrapped with rolling paper by a wrapper to create a continuous rod. A cutter subsequently divides the continuous rod into individual rods.

### TECHNICAL FIELD

The present invention relates to a manufacturing machine for a rod used in a flavor inhaler, and a method for manufacturing the rod.

### BACKGROUND ART

PTL 1 discloses a method for crimping a sheet-like web of material for the tobacco industry. The method includes a step for measuring the thickness of the web before a step for crimping the web, and the step for crimping the web is adjusted as a function of the measured value of the thickness of the web.

PTL 2 discloses a method for crimping a sheet. In the method, sheet properties such as the thickness, moisture, composition, and width of the sheet are measured before and after crimping the sheet, and the sheet nip size (crimping depth) of crimping rollers is adjusted on the basis of the sheet properties before and after crimping.

### CITATION LIST

### Patent Literature

PTL 1: WO 2019/123210 A1
PTL 2: WO 2021/136612 A1

### SUMMARY OF INVENTION

### Technical Problem

The sheet in each of PTL 1 and 2 is continuously unwound from a wound roll and is fed to a conveying path, and the sheet properties discussed hereinabove are measured while the sheet is being conveyed. Therefore, since the sheet is prone to becoming wrinkled during conveying and moves slightly during conveying, it is difficult to accurately measure the sheet properties. In particular, in the sheet after crimping, the fibers are liable to defibrate or become torn, or to soften as a result of the crimping, thus making the sheet even more prone to wrinkling, and therefore errors are liable to occur in the measurement of the sheet properties.

Furthermore, in PTL 2, the crimping depth of the sheet is adjusted on the basis of the sheet properties before and after crimping, but by measuring the sheet properties at two places, i.e. before and after crimping, measurement errors in the sheet properties become even more pronounced. In addition, the sheet that has been subjected to such crimp processing is gathered in a width direction intersecting the longitudinal direction, is wrapped with rolling paper, and is then cut to produce a rod for use in a flavor inhaler.

However, when parameters relating to the crimp processing of the sheet are controlled on the basis of the measured sheet properties, if, as discussed above, there are large measurement errors in the sheet properties, the parameters relating to the crimp processing of the sheet cannot be controlled to desired values, and it is difficult to control the rod ventilation resistance, for example, which depends on the degree of the sheet crimp processing, to an optimal value.

The present invention takes account of such problems, and the objective thereof lies in providing a manufacturing machine for a rod used in a flavor inhaler, and a method for manufacturing the rod, in which it is possible to control parameters relating to crimp processing of a sheet to desired values.

### Solution to Problem

In order to achieve the above objective, a manufacturing machine for a rod used in a flavor inhaler according to one aspect comprises a sheet supply section for continuously feeding out a sheet from a roll on which the sheet has been wound and supplying the sheet to a conveying path, a sheet processing section for subjecting the sheet conveyed to the conveying path to crimp processing, a gathering section for gathering the sheet, which has been subjected to the crimp processing in the sheet processing section, in a width direction intersecting a longitudinal direction thereof, to form a bundled rod, a wrapping section for wrapping the bundled rod formed in the gathering section with a supplied rolling paper while reducing the diameter of the bundled rod, to form a continuous rod, and a cutting section for cutting the continuous rod formed by the wrapping section into rods, wherein the sheet processing section comprises: a diameter detecting unit for detecting the diameter of the roll from which the sheet is being fed out; and a control unit for controlling a parameter relating to the crimp processing of the sheet on the basis of the diameter detected by the diameter detecting unit.

A manufacturing method for a rod used in a flavor inhaler according to one aspect includes a sheet supply step for continuously feeding out a sheet from a roll on which the sheet has been wound and supplying the sheet to a conveying path, a sheet processing step for performing a crimping process for subjecting the sheet conveyed to the conveying path to crimp processing, a gathering step for gathering the sheet, which has been subjected to the crimp processing in the sheet processing step, in a width direction intersecting a longitudinal direction thereof, to form a bundled rod, a wrapping step for wrapping the bundled rod formed in the gathering step with a supplied rolling paper while reducing the diameter of the bundled rod, to form a continuous rod, and a cutting step for cutting the continuous rod formed in the wrapping step into rods, wherein the sheet processing step comprises: a diameter detecting process for detecting the diameter of the roll from which the sheet is being fed out; and a control process for controlling a parameter relating to the crimping process on the basis of the diameter detected by the diameter detecting process.

### Advantageous Effects of Invention

According to the above aspects, in the rod used in a flavor inhaler, a parameter relating to the sheet crimp processing can be controlled to a desired value.

### BRIEF DESCRIPTION OF DRAWINGS

FIG. 1 is a schematic diagram of a manufacturing machine for a rod used in a flavor inhaler.

FIG. 2 is a flowchart illustrating a manufacturing method for a rod used in a flavor inhaler.

FIG. 3 is an oblique view of a set of rollers, and a configuration diagram of a sheet processing section.

FIG. 4 is a table listing the numerical values of roll diameter, sheet thickness, meshing depth and rod ventilation resistance in accordance with the region in which the sheet is positioned in each case.

FIG. 5 is a cross-sectional view in a situation in which the sheet in an outer region of the roll is being crimped in meshing portions.

FIG. 6 is a cross-sectional view in a situation in which the sheet in an intermediate region of the roll is being crimped in the meshing portions.

FIG. 7 is a cross-sectional view in a situation in which the sheet in an inner region of the roll is being crimped in the meshing portions.

FIG. 8 is a longitudinal cross-sectional view of a rod.

FIG. 9 is a lateral cross-sectional view of a flavor inhaler.

FIG. 10 is a lateral cross-sectional view of another form of flavor inhaler.

### DESCRIPTION OF EMBODIMENTS

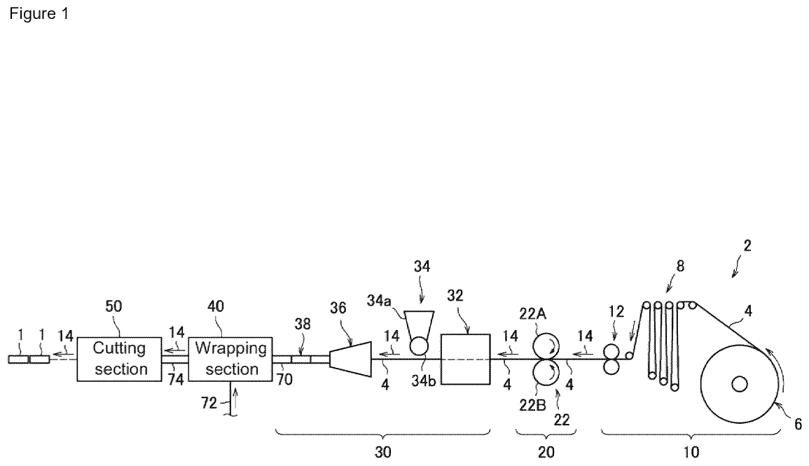

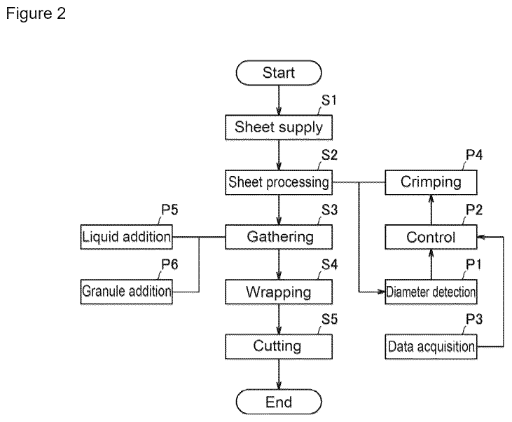

FIG. 1 is a schematic diagram of a manufacturing machine 2 for a rod 1 used in a flavor inhaler, and FIG. 2 is a flowchart illustrating a manufacturing method for the rod 1. The manufacturing machine 2 comprises, in order from the upstream side in the conveying direction of a sheet 4: a sheet supply section 10; a sheet processing section 20; a gathering section 30; a wrapping section 40; and a cutting section 50. The sheet supply section 10 comprises a roll 6, a plurality of guide rollers 8 and feed rollers 12.

The roll 6 is formed by winding a sheet 4 such as a paper web. Any of the guide rollers 8 are dancing rollers that are permitted to move up and down, and that impart tension to the sheet 4 being conveyed. The feed rollers 12 comprise a pair of rollers, at least one of the rollers being a motor driven drive roller that pulls and feeds out the sheet 4.

When production of the rods 1 begins, the sheet supply section 10 configured in this way continuously feeds out the sheet 4 from the roll 6 via the guide rollers 8 and the feed rollers 12, and supplies the sheet 4 to a conveying path 14 of the sheet 4 in the manufacturing machine 2 (S1: sheet supply step). Next, the sheet processing section 20 subjects the sheet being 4 conveyed along the conveying path 14 to crimp processing (S2:sheet processing step).

The sheet processing section 20 comprises a set of rollers 22 which, in a sheet processing step S2, subject the sheet 4 to crimp processing by conveying the sheet 4 along the conveying path 14 by sandwiching the sheet between a first roller 22A and a second roller 22B (P4: crimping process). It should be noted that at least one of the first and second rollers 22A and 22B is a motor driven drive roller which pulls and feeds out the sheet 4.

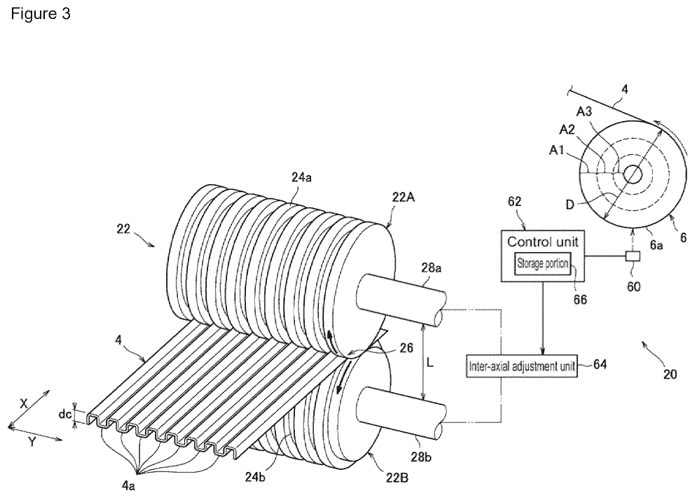

FIG. 3 is an oblique view of the set of rollers 22, and a configuration diagram of the sheet processing section 20. Projecting ridges 24a are formed along the circumferential direction of the outer circumferential surface of the first roller 22A. Recesses that 24b mesh with the ridges 24a are formed along the circumferential direction of the outer circumferential surface of the second roller 22B. When the set of rollers 22 sandwich and convey the sheet 4, the first and second rollers 22A and 22B rotate respectively in the direction of the arrows shown in FIG. 3, causing the ridges 24a and recesses 24b to mesh with one another with the sheet 4 interposed therebetween, thereby forming a plurality of meshing portions 26 in the set of rollers 22.

By forming the meshing portions 26, a plurality of crimped portions 4a corresponding to the number of meshing portions 26 are formed side by side in the width direction Y of the sheet 4. It should be noted that the crimp processing is creping in which the sheet 4 is shaped with recesses and protrusions, with gaps therebetween. Furthermore, the crimped portions 4a are irregular wrinkles, and are defined as recessed portions having various shapes that are recessed from the flat surface of the sheet, or protruding portions having various shapes that protrude from the flat surface of the sheet 4.

The sheet processing section 20 further comprises a diameter detecting unit 60, a control unit 62 and an inter-axial adjustment unit 64. In the sheet processing step S2, the diameter detecting process 60 detects the diameter D of the roll 6 from which the sheet 4 is being fed out (P1: diameter detecting process). The diameter detecting unit 60 is, for example, a laser displacement meter which measures the distance from the diameter detecting unit 60 to the outer circumferential surface 6a of the roll 6, without contacting the roll, 6 by receiving reflected light when laser light is shone onto the outer circumferential surface 6a of the roll 6, and detecting the diameter D of the roll 6 by calculation on the basis of this distance.

In the sheet processing step S2, the control unit 62 controls a parameter relating to the crimp processing of the sheet 4 on the basis of the diameter D detected by the diameter detecting unit 60 (P2:control process). More specifically, the control unit 62 includes a storage portion 66 in which data relating to the thickness t of the sheet 4 wound at a position corresponding to the diameter D of the roll 6 are stored in advance. Such data relating to the thickness t of the sheet 4 are acquired in the sheet processing step S2 from the storage portion 66 as data corresponding to the diameter D of the roll 6 detected by the diameter detecting unit 60 (P3: data acquisition process).

The control process P2 controls the parameter relating to the crimping process P4 on the basis of the thickness t that is acquired in the data acquisition process P3 and that corresponds to the diameter D detected in the diameter detecting process P1. In the present embodiment, the roll 6 is divided into an outer region A1, an intermediate region A2 and an inner region A3 when viewed in the radial direction of the roll 6, and the data relating to the thickness t of the sheet 4 wound in each region A1, A2 and A3 are stored in advance in the storage portion 66 (the data corresponding to the outer region A1 being t1, the data corresponding to the intermediate region A2 being t2, and the data corresponding to the inner region A3 being t3).

Furthermore, in the present embodiment, the parameter to be controlled in the control process P2 is a crimping depth dc of the crimped portions 4a formed in the sheet 4. The control unit 62 controls the inter-axial adjustment unit 64 to adjust the crimping depth dc of the crimped portions 4a. More specifically, the inter-axial adjustment unit 64 adjusts an inter-axial distance L between a rotational axis 28a of the first roller 22A and a rotational axis 28b of the second roller 22B. The control unit 62 controls the inter-axial adjustment unit 64 to adjust the inter-axial distance L, to thereby control a meshing depth de of the meshing portions 26 and in turn control the crimping depth dc of the sheet 4.

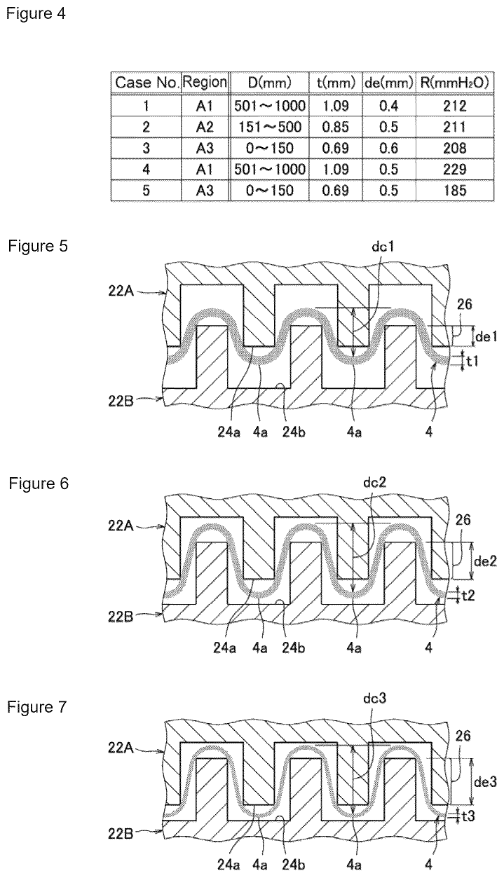

FIG. 4 shows a table listing the numerical values of the diameter D of the roll 6, the thickness t of the sheet 4, the meshing depth de, and the ventilation resistance R of the rods 1 in accordance with the region A1, A2, A3 in which the sheet 4 is positioned in each case. Further, FIG. 5 shows a cross-sectional view in a situation in which the sheet 4 in the outer region A1 of the roll 6 is being crimped in the meshing portions 26. The sheet 4 positioned in the outer region A1 has a relatively small number of turns of the sheet 4 located above said sheet 4 in the roll 6, and consequently this part of the sheet 4 is subjected to a relatively small load.

Therefore, the pressing force applied to the sheet 4 in the outer region A1 of the roll 6 is relatively small, and the sheet 4 has a large thickness t1 that is close to the state of the sheet 4 immediately after production. That is, if the sheet 4 to be crimped is in the outer region A1 part of the roll 6, the sheet 4 to be crimped has a relatively large thickness t1. Therefore, by adjusting the inter-axial distance L by means of the inter-axial adjustment unit 64, the meshing depth de of the meshing portions 26 is controlled to a relatively small de1, and as a result the crimping depth dc of the sheet 4 is controlled to a relatively small dc1.

In this way, when the thickness t of the sheet 4 is large, the ventilation resistance R of the rod 1 is made to approach a target value, without becoming excessively large, by decreasing the meshing depth de and thus decreasing the crimping depth dc. Specifically, in the example of Case No. 1 shown in FIG. 4, the detected diameter D of the roll 6 is in the range of 501 mm to 1000 mm (outer region A1), and consequently the control unit 62 acquires the data 1.09 mm (t1) from the storage portion 66 as the thickness t of the sheet 4.

Next, the inter-axial adjustment unit 64 adjusts the inter-axial distance L on the basis of a command from the control unit 62, to set the meshing depth de of the meshing portions 26 to 0.4 mm (de1), set in advance as the numerical value corresponding to t1. As a result, the crimping depth dc of the sheet 4 is dc1, and the ventilation resistance R of the produced rod 1 is 212 mmH₂O, which is close to the target value of 210 mmH₂O.

FIG. 6 shows a cross-sectional view in a situation in which the sheet 4 in the intermediate region A2 of the roll 6 is being crimped in the meshing portions 26. The sheet 4 positioned in the intermediate region A2 has a greater number of turns of the sheet 4 located above said sheet 4 in the roll 6 than the sheet 4 positioned in the outer region A1, and consequently this part of the sheet 4 is subjected to a greater load than that in the outer region A1. Therefore, the pressing force applied to the sheet 4 in the intermediate region A2 of the roll 6 is greater than that in the outer region A1, and thus the sheet 4 is pressed slightly and has a smaller thickness t2 than that in the outer region A1.

That is, if the sheet 4 to be crimped is in the intermediate region A2 part of the roll 6, the sheet 4 to be crimped has a thickness t2 that is smaller than t1. Therefore, by adjusting the inter-axial distance L by means of the inter-axial adjustment unit 64, the meshing depth de of the meshing portions 26 is controlled to de2, which is larger than de1, and as a result the crimping depth dc of the sheet 4 is controlled to dc2, which is larger than dc1.

In this way, when the thickness t of the sheet 4 is small, the ventilation resistance R of the rod 1 is made to approach the target value, without becoming excessively small, by increasing the meshing depth de and thus increasing the crimping depth dc. Specifically, in the example of Case No. 2 shown in FIG. 4, the detected diameter D of the roll 6 is in the range of 151 mm to 500 mm (intermediate region A2), and consequently the control unit 62 acquires the data 0.85 mm (t2) from the storage portion 66 as the thickness t of the sheet 4.

Next, the inter-axial adjustment unit 64 adjusts the inter-axial distance L on the basis of a command from the control unit 62, to set the meshing depth de of the meshing portions 26 to 0.5 mm (de2), set in advance as the numerical value corresponding to t2. As a result, the crimping depth dc of the sheet 4 is dc2, which is greater than dc1, and the ventilation resistance R of the produced rod 1 is 211 mmH₂O, which is close to the target value of 210 mmH₂O.

FIG. 7 shows a cross-sectional view in a situation in which the sheet 4 in the inner region A3 of the roll 6 is being crimped in the meshing portions 26. The sheet 4 positioned in the inner region A3 has a greater number of turns of the sheet 4 located above said sheet 4 in the roll 6 than the sheet 4 positioned in the intermediate region A2, and consequently this part of the sheet 4 is subjected to a greater load than that in the intermediate region A2. Therefore, the pressing force applied to the sheet 4 in the inner region A3 of the roll 6 is greater than that in the intermediate region A2, and thus the sheet 4 is pressed more and has a smaller thickness t3 than that in the intermediate region A2.

That is, if the sheet 4 to be crimped is in the inner region A3 part of the roll 6, the sheet 4 to be crimped has a thickness t3 that is smaller than t2. Therefore, by adjusting the inter-axial distance L by means of the inter-axial adjustment unit 64, the meshing depth de of the meshing portions 26 is controlled to de3, which is larger than de2, and as a result the crimping depth dc of the sheet 4 is controlled to dc3, which is larger than dc2.

In this way, when the thickness t of the sheet 4 is even smaller, the ventilation resistance R of the rod 1 is made to approach the target value, without becoming excessively small, by further increasing the meshing depth de and thus further increasing the crimping depth dc. Specifically, in the example of Case No. 3 shown in FIG. 4, the detected diameter D of the roll 6 is in the range of 0 mm to 150 mm (inner region A3), and consequently the control unit 62 acquires the data 0.69 mm (t3) from the storage portion 66 as the thickness t of the sheet 4.

Next, the inter-axial adjustment unit 64 adjusts the inter-axial distance L on the basis of a command from the control unit 62, to set the meshing depth de of the meshing portions 26 to 0.6 mm (de3), set in advance as the numerical value corresponding to t3. As a result, the crimping depth dc of the sheet 4 is dc3, which is greater than dc2, and the ventilation resistance R of the produced rod 1 is 208 mmH₂O, which is close to the target value of 210 mmH₂O.

Meanwhile, in the comparative example of Case No. 4 shown in FIG. 4, the diameter D of the roll 6 is positioned in the outer region A1, as in Case No. 1, and consequently the data 1.09 mm (t1) is acquired from the storage portion 66 as the thickness t of the sheet 4. However, the inter-axial adjustment unit 64 adjusted the meshing depth de of the meshing portions 26 not to 0.4 mm, which corresponds to t1, but to 0.5 mm, which is slightly larger. As a result, the ventilation resistance R of the rod 1 was 229 mmH₂O, which is excessively large compared to the target value of 210 mmH₂O.

Further, in the comparative example of Case No. 5 shown in FIG. 4, the diameter D of the roll 6 is positioned in the inner region A3, as in Case No. 3, and consequently the data 0.69 mm (t3) is acquired from the storage portion 66 as the thickness t of the sheet 4. However, the inter-axial adjustment unit 64 adjusted the meshing depth de of the meshing portions 26 not to 0.69 mm, which corresponds to t3, but to 0.5 mm, which is slightly smaller. As a result, the ventilation resistance R of the rod 1 was 185 mmH₂O, which is excessively small compared to the target value of 210 mmH₂O.

As will be apparent from these comparative examples, in addition to data relating to the thickness t of the sheet corresponding to the diameter D of the roll 6, the meshing depth de corresponding to the thickness t of the sheet 4 is also important. Therefore, it is preferable that the storage portion 66 stores in advance not only data relating to the thickness t of the sheet 4 corresponding to the diameter D of the roll 6, but also data relating to the meshing depth de associated with the thickness t of the sheet 4, and thus relating to the inter-axial distance L. As a result, when the control process P2 is performed, data relating to the meshing depth de, and thus to the inter-axial distance L, based on the diameter D of the roll 6 are acquired from the storage portion 66, allowing the inter-axial distance L to be easily adjusted to an optimal value by means of the inter-axial adjustment unit 64.

Next, the sheet 4 passes through the sheet processing section 20 configured as described hereinabove, and reaches the gathering section 30. As shown in FIG. 1 and FIG. 2, the gathering section 30 gathers the sheet 4, which has been subjected to the crimp processing in the sheet processing section 20, in a width direction Y intersecting a longitudinal direction X (see FIG. 3), in other words, gathers and bundles the sheet 4 to reduce the diameter thereof, to form a bundled rod 70 (S3: gathering step).

More specifically, the gathering section 30 comprises, in order from the upstream side in the conveying direction of the conveying path 14: a liquid adding booth 32; a granule adding unit 34; a trumpet guide 36; and a tong 38. The liquid adding booth 32 sprays a liquid additive onto the sheet 4 prior to gathering (P5: liquid adding process). The additive is, for example, a liquid containing a plasticizer or a fragrance.

The granule adding unit 34 comprises a hopper 34a and a spreading roller 34b. The hopper 34a stores granules, and the spreading roller 34b spreads the granules supplied from the hopper 34a onto the sheet 4 prior to gathering (P6: granule adding process). The granules are granular additives including particles of activated charcoal or fragrance, for example.

The trumpet guide 36 has a tubular shape with an inner circumferential surface that gradually decreases in diameter from the upstream side of the conveying path 14, and the trumpet guide 36 randomly gathers the sheet 4 that is being conveyed along the conveying path 14 into a rod shape while reducing the diameter thereof, and discharges it toward the tubular tong 38. As the gathered rod-shaped sheet 4 passes through the tong 38, the rod-shaped sheet 4 is further reduced in diameter to form the bundled rod 70.

Next, the wrapping section 40 wraps the bundled rod 70 formed in the gathering section 30 with supplied rolling paper 72 while reducing the diameter thereof, to form a continuous rod 74 (S4: wrapping step). The cutting section 50 then cuts the continuous rod 74 formed in the wrapping section 40 into individual rods 1 (S5: cutting step). The rods 1 produced in this way are used as various filling elements constituting a flavor inhaler.

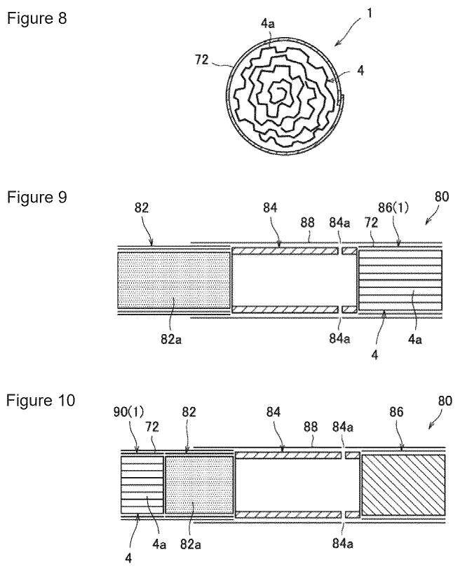

FIG. 8 shows a longitudinal cross-sectional view of the rod 1. The rod 1 is formed by gathering and reducing the diameter of sheets 4 in which a large number of crimped portions 4a have been formed, and wrapping the gathered sheets 4 with rolling paper 72. In the present embodiment, as discussed hereinabove, by controlling the crimping depth dc of the crimped portions 4a in accordance with the thickness t of the sheet 4 constituting the roll 6, the void ratio in the rod 1 can be controlled and thus the ventilation resistance R of the rod 1 can be made to approach a target value.

FIG. 9 shows a lateral cross-sectional view of a flavor inhaler 80 provided with a rod 1. The flavor inhaler 80 (hereinafter also referred to simply as the article 80) is of a heat-not-burn type, and comprises a flavor element 82, a cooling element 84, and a filter element 86. The elements 82, 84 and 86 are arranged butted together side-by-side in the axial direction, and are then wrapped with a tipping paper 88 to form the article 80.

The flavor element 82 is heated by means of a heater of a device (flavor inhalation implement), not shown, which causes volatilization of flavor components in a flavoring material 82a. The flavoring material 82a may, for example, be shredded tobacco, shredded tobacco sheets, or tobacco sheets folded in a gathered shape. The flavoring material 82a may equally be a sheet formed from pulp that does not contain tobacco, with flavoring added thereto, a shredded sheet made from a non-tobacco plant, or such sheets folded into a corrugated shape.

The cooling element 84 is, for example, a cylindrical paper tube formed from a single or double layer paper web, and forms an airflow path in the article 80. A plurality of ventilation holes 84a for drawing air into the article 80 when the article 80 is sucked are formed in the circumferential surface of the cooling element 84. In the cooling element 82, the air drawn in from the vent holes 84a cools the flavor components volatilized from the flavor element 82, forming an aerosol, and the user inhales the aerosol that has passed through the filter element 86.

In the case shown in FIG. 9, the rod 1 is used as the filter element 86, having a ventilation resistance that is optimal for a filter body. It should be noted that the rod 1 can also be used as the flavor element 82 or the cooling element 84 by selecting the material of the sheet 4. The sheet 4 can be formed from various materials, such as paper, non-woven fabric, tobacco sheet, or film, depending on the application for which the rod 1 is to be used. Furthermore, various thicknesses t of the sheet 4 can be selected, for example 100 μm, 200 μm, 500 μm, etc. However, with respect to controlling the crimping depth dc, as the parameter relating to the crimping process P4, it is preferable that the sheet 4 has a thickness t of at least 100 μm, in order for the effect of said control to be reflected suitably in the rod properties, such as the ventilation resistance R.

FIG. 10 shows a lateral cross-sectional view of another form of flavor inhaler 80 provided with a rod 1. In this article 80, the rod 1 is used as a plug element 90 disposed at the tip, adjacent to the flavor element 82. In this case, the sheet 4 may be a paper web or a non-woven fabric. If the sheet 4 is a non-woven fabric, it is preferable to use a dry non-woven fabric in which plant pulp is bonded to itself using a water-soluble binder. Wood pulp from a non-tobacco plant may be used as the plant pulp.

Furthermore, a liquid additive is preferably added to the sheet 4. The additive is heated by the heater of the device together with the flavor element 82, causing the components of the additive to volatilize. The additive may, for example, be a flavoring liquid, and may contain a tobacco extract solution. Further, since the plug element 90 is positioned at the tip of the article 80, in one sense the plug element 90 also functions as a support element, suppressing spilling of the flavoring material 82a from the flavor element 82. It should be noted that, although not shown, the rod 1 can also be used as a filter element or a cooling element of combustion heating type flavor inhaler.

As described hereinabove, the manufacturing machine 2 of the rod 1 of the embodiment comprises the sheet supply section 10, the sheet processing section 20, the gathering section 30, the wrapping section 40 and the cutting section 50, and the sheet processing section 20 includes the diameter detecting unit 60 and the control unit 62. In the diameter detecting process P1, the diameter detecting unit 60 detects the diameter of the roll 6 from which the sheet 4 is being fed out. In the control process P2, the control unit 62 controls the parameter relating to the crimping process P4 on the basis of the diameter D detected by the diameter detecting unit 60.

That is, the manufacturing machine 2 indirectly detects the sheet property of the sheet 4 being conveyed from the diameter D of the roll 6, and controls the parameter relating to the crimp processing of the sheet 4 on the basis of the indirectly detected sheet property. This allows the parameter relating to the crimp processing of the sheet 4 to be controlled to a desired value without being affected by measurement errors that arise if the sheet 4 is measured while being conveyed. Therefore, the rod properties such as the ventilation resistance R of the rod 1, which depend on the degree of the sheet 4 crimp processing, can be controlled to optimal values.

Further, the control unit 62 also includes a storage portion 66 for storing data relating to the thickness t of the sheet 4 wound at a position corresponding to the diameter D of the roll 6. The control unit 62 acquires the thickness t of the sheet 4 corresponding to the diameter D detected by the diameter detecting unit 60 from the storage portion 66 in the data acquisition process P3, and controls the parameter relating to the crimping process P4 on the basis of the acquired thickness t.

Here, for the same type of roll 6, even if a new roll 6 is set or the lot of the roll 6 to be set is changed, the thickness t of the sheet 4 corresponding to the winding position of the sheet 4 in the roll 6 does not change significantly. Therefore, by measuring the data relating to the thickness t of the sheet 4 corresponding to the diameter D off-line, storing the data in advance in the storage portion 66, and then acquiring the data from the storage portion 66 for use each time it is required, the parameter relating to the crimp processing of the sheet 4 can be controlled easily and reliably without being affected by the measurement errors discussed hereinabove.

Furthermore, the parameter to be controlled in the control process P2 is the crimping depth dc of the crimped portions 4a formed in the sheet 4. In this way, by controlling the crimping depth de, which is a parameter that directly affects the degree of crimping of the sheet 4, rod properties such as the ventilation resistance R, which are easily affected by the degree of crimping of the sheet 4, can be more reliably controlled.

Further, the sheet processing section 20 includes the set of rollers 22 and the inter-axial adjustment unit 64. The control unit 62 controls the inter-axial adjustment unit 64 to adjust the inter-axial distance L, to thereby control the meshing depth de of the meshing portions 26 and in turn control the crimping depth dc. This allows the crimping depth dc of the sheet 4 to be easily controlled over the entire area of the sheet 4.

Further, the diameter detecting unit 60 is a laser displacement meter, for example, and detects the diameter D in the diameter detecting process P1 without contacting the roll 6. This makes it possible to prevent wrinkles and tears from occurring in the sheet 4 as a result of the diameter detecting unit 60 coming into contact with the roll 6. Therefore, the measurement of the diameter D, and hence the control of the parameter relating to the crimp processing of the sheet 4, can be carried out more reliably.

In addition, in the sheet supply step S10, the sheet supply section 10 continuously feeds out the sheet 4 from the roll 6 on which the sheet 4 having a thickness t of 100 μm or more has been wound, and supplies the sheet to the conveying path 14. As a result, with respect to controlling the crimping depth dc as the parameter relating to the crimping process P4, since the effect of this control can be suitably exhibited, the parameter relating to the crimp processing of the sheet 4 can be more reliably controlled.

This concludes the description of the embodiments, but the embodiments described above are not limiting, and may be modified in various ways within a scope that does not depart from the essential point of the present invention. For example, in the case of the above embodiments, the roll 6 is divided into the outer region A1, the intermediate region A2 and the inner region A3 when viewed in the radial direction of the roll 6, and data relating to the thickness t1, t2, t3 of the sheet 4 corresponding to each region A1, A2, A3 are stored in advance in the storage portion 66. However, the configuration is not limited thereto, and the roll 6 may be divided into four or more smaller regions in the radial direction, and more data relating to the thickness t of the sheet 4 corresponding to each region may be stored. This allows for more precise control of the parameter relating to the crimp processing of the sheet 4.

Further, the diameter detecting unit 60 may be a contact-type detecting unit that comes into contact with the roll 6 to detect the diameter D, provided that the sheet 4 does not become wrinkled or torn. Furthermore, the diameter D may be calculated not only using a displacement meter (distance measuring meter), but may also be calculated from the rotational speed of the roll 6, the conveying speed of the sheet 4 in the conveying path 14, the production speed of the rods 1, or the elapsed time since the start of manufacture of the rods 1.

Furthermore, there is a time lag before the sheet 4 that has been detected in the diameter detecting process P1 is actually crimped in the crimping process P4. Therefore, in the control process P2, it is preferable to perform delay control taking into account said time lag. Furthermore, in the above embodiments, the parameter to be controlled on the basis of the diameter D of the roll 6 is not limited to the crimping depth dc, and the width of the crimped portions 4a in the width direction Y of the sheet 4, the number of crimped portions 4a in the width direction Y of the sheet 4, and the position of the crimped portions 4a in the longitudinal direction X and the width direction Y of the sheet 4, etc., may be controlled on the basis of the diameter D of the roll 6.

Furthermore, the memory 66 may store not only data relating to the thickness t of the sheet 4 corresponding to the diameter D of the roll 6, but also data relating to the meshing depth de, the crimping depth dc, the inter-axial distance L, and the ventilation resistance R, linked to the diameter D and the thickness t. This allows various useful pieces of data to be acquired from the storage portion 66 in the data acquisition process P3, thereby enabling the parameter relating to the crimp processing of the sheet 4 to be controlled with even greater precision.

The storage portion 66 does not need to store data relating to the thickness t of the sheet 4 corresponding to the diameter D of the roll 6, and may store the parameter relating to the crimp processing of the sheet corresponding to the diameter D of the roll 6. That is, it may store the diameter D of the roll 6, and data relating to at least one of the meshing depth de, the crimping depth de, and the inter-axial distance L to be controlled when the diameter has been detected. This allows for savings in the capacity of the storage unit 66.

Further, the rod property to be controlled as the final objective is not limited to the ventilation resistance R of the rod 1, and other rod properties such as flavor generation properties, cooling properties, support strength properties, etc., may be selected in accordance with the function that the rod 1 fulfills in the article 80. In addition, sheet properties such as the thickness t may be measured as appropriate along the conveying path 14. In this case, it is also possible to perform feedback control in the control process P2 using the actually measured sheet properties, in combination with the indirect control of the above embodiments.

In addition, the embodiments described above may be expressed, in part or in full, by the disclosure of the aspects given below.

### Aspect 1

A manufacturing machine for a rod used in a flavor inhaler, the manufacturing machine comprising a sheet supply section for continuously feeding out a sheet from a roll on which the sheet has been wound and supplying the sheet to a conveying path,
a sheet processing section for subjecting the sheet conveyed to the conveying path to crimp processing,
a gathering section for gathering the sheet, which has been subjected to the crimp processing in the sheet processing section, in a width direction intersecting a longitudinal direction thereof, to form a bundled rod,
a wrapping section for wrapping the bundled rod formed in the gathering section with a supplied rolling paper while reducing the diameter of the bundled rod, to form a continuous rod, and
a cutting section for cutting the continuous rod formed by the wrapping section into rods, wherein
the sheet processing section comprises:
a diameter detecting unit for detecting the diameter of the roll from which the sheet is being fed out; and
a control unit for controlling a parameter relating to the crimp processing of the sheet on the basis of the diameter detected by the diameter detecting unit.

### Aspect 2

The manufacturing machine for a rod used in a flavor inhaler as described in aspect 1, wherein the parameter is a crimping depth of crimped portions formed in the sheet.

### Aspect 3

The manufacturing machine for a rod used in a flavor inhaler as described in aspect 2, wherein the sheet processing section comprises
a set of rollers that subject the sheet to crimp processing by conveying the sheet along the conveying path by sandwiching the sheet between a first roller and a second roller, and
an inter-axial adjustment unit that adjusts an inter-axial distance between the rotational axis of the first roller and the rotational axis of the second roller,
and wherein:
projecting ridges are formed along the circumferential direction of an outer circumferential surface of the first roller;
recesses that mesh with the ridges are formed along the circumferential direction of an outer circumferential surface of the second roller;
when sandwiching and conveying the sheet, the set of rollers form meshing portions in which the ridges and the recesses mesh with one another with the sheet interposed therebetween; and the control unit controls the inter-axial adjustment unit to adjust the inter-axial distance, to thereby control a meshing depth of the meshing portions and in turn control the crimping depth.

### Aspect 4

The manufacturing machine for a rod used in a flavor inhaler as described in aspect 1, wherein the diameter detecting unit detects the diameter without contacting the roll.

### Aspect 5

The manufacturing machine for a rod used in a flavor inhaler as described in aspect 1, wherein the control unit includes a storage portion for storing data relating to the thickness of the sheet wound at a position corresponding to the diameter, acquires, from the storage portion, the thickness corresponding to the diameter detected by the diameter detecting unit, and controls the parameter relating to crimp processing of the sheet on the basis of the obtained thickness.

### Aspect 6

The manufacturing machine for a rod used in a flavor inhaler as described in any one of aspects 1 to 5, wherein the sheet supply section continuously feeds out the sheet from the roll on which the sheet having a thickness of 100 m or more has been wound, and supplies the sheet to the conveying path.

### Aspect 7

A manufacturing method for a rod used in a flavor inhaler, the manufacturing method including a sheet supply step for continuously feeding out a sheet from a roll on which the sheet has been wound and supplying the sheet to a conveying path,
a sheet processing step for performing a crimping process for subjecting the sheet conveyed to the conveying path to crimp processing,
a gathering step for gathering the sheet, which has been subjected to the crimp processing in the sheet processing step, in a width direction intersecting a longitudinal direction thereof, to form a bundled rod,
a wrapping step for wrapping the bundled rod formed in the gathering step with a supplied rolling paper while reducing the diameter of the bundled rod, to form a continuous rod, and a cutting step for cutting the continuous rod formed in the wrapping step into rods,
wherein
the sheet processing step comprises:
a diameter detecting process for detecting the diameter of the roll from which the sheet is being fed out; and
a control process for controlling a parameter relating to the crimping process on the basis of the diameter detected by the diameter detecting process.

### Aspect 8

The manufacturing method for a rod used in a flavor inhaler as described in aspect 7, wherein the control process controls the crimping depth for the sheet as the parameter.

### Aspect 9

The manufacturing method for a rod used in a flavor inhaler as described in aspect 8, wherein, in the diameter detecting process, the diameter is detected without contact with the roll.

### Aspect 10

The manufacturing method for a rod used in a flavor inhaler as described in aspect 7, wherein the sheet processing step further comprises a data acquisition process for acquiring data relating to the thickness of the sheet corresponding to the diameter, and
the control process controls the parameter relating to the crimping process on the basis of the thickness that is acquired in the data acquisition process and that corresponds to the diameter detected in the diameter detecting process.

### Aspect 11

The manufacturing method for a rod used in a flavor inhaler as described in any one of aspects 7 to 10, wherein, in the sheet supply step, the sheet is continuously fed out from the roll on which the sheet having a thickness of 100 m or more has been wound, and is supplied to the conveying path.

### REFERENCE SIGNS LIST

1 Rod
2 Manufacturing machine
4 Sheet
4a Crimped portion
6 Roll
10 Supply section
14 Conveying path
20 Sheet processing section
22 Set of rollers
22A First roller
22B Second roller
24a Ridge
24b Recess
26 Meshing portion
28a Rotational axis of first roller
28b Rotational axis of second roller
30 Gathering section
40 Wrapping section
50 Cutting section
60 Diameter detecting unit
62 Control unit
64 Inter-axial adjustment unit
66 Storage portion
70 Bundled rod
72 Rolling paper
74 Continuous rod
80 Flavor inhaler
D Diameter
t Thickness
dc Parameter (crimping depth)
de Meshing depth
L Inter-axial distance
X Longitudinal direction
Y Width direction
S1 Sheet supply step
S2 Sheet processing step
S3 Gathering step
S4 Wrapping step
S5 Cutting step
P1 Diameter detecting process
P2 Control process
P3 Data acquisition process
P4 Crimping process

1.-11. (canceled)

12. A manufacturing machine for a rod used in a flavor inhaler comprising:
rollers configured to feed a sheet from a roll to a conveying path;
a set of rollers configured to crimp the sheet;
a sensor configured to detect a diameter of the roll;
circuitry configured to control a parameter relating to crimping of the sheet based on the detected diameter;
a trumpet guide and tong configured to gather the crimped sheet in a width direction to form a bundled rod;
a wrapper configured to wrap the bundled rod with rolling paper to form a continuous rod; and
a cutter configured to cut the continuous rod into rods.

13. The manufacturing machine as claimed in claim 12, wherein
the parameter is a crimping depth of a crimped portion formed in the sheet.

14. The manufacturing machine as claimed in claim 13, wherein
projecting ridges are formed along a circumferential direction of an outer circumferential surface of a first roller of the set of rollers,
recesses that mesh with the ridges are formed along a circumferential direction of an outer circumferential surface of a second roller of the set of rollers,
when sandwiching and conveying the sheet, the set of rollers form meshing portions in which the ridges and the recesses mesh with one another with the sheet interposed therebetween, and
the circuitry is configured to control an inter-axial distance between a rotational axis of the first roller and a rotational axis of the second roller to thereby control a meshing depth of the meshing portions and in turn control the crimping depth.

15. The manufacturing machine as claimed in claim 12, wherein
the sensor is configured to detect the diameter without contacting the roll.

16. The manufacturing machine as claimed in claim 15, wherein
the sensor comprises a laser displacement meter.

17. The manufacturing machine as claimed in claim 12, wherein
the circuitry includes memory for storing data relating to a thickness of the sheet wound at a position corresponding to the diameter, the circuitry being configured to acquire, from the memory, the thickness corresponding to the detected diameter, and to control the parameter relating to crimp processing of the sheet based on the acquired thickness.

18. The manufacturing machine as claimed in claim 17, wherein
the roll is divided into a plurality of regions when viewed in a radial direction, and
the memory stores data relating to the thickness of the sheet corresponding to each region.

19. The manufacturing machine as claimed in claim 17, wherein
the memory stores data relating to at least one of a meshing depth, a crimping depth, and an inter-axial distance corresponding to the diameter.

20. The manufacturing machine as claimed in claim 12, wherein
the sheet has a thickness of 100 μm or more.

21. The manufacturing machine as claimed in claim 12, further comprising:
a liquid adding booth configured to spray a liquid additive onto the sheet.

22. The manufacturing machine as claimed in claim 12, further comprising:
a hopper configured to store granules; and
a spreading roller configured to spread the granules onto the sheet.

23. The manufacturing machine as claimed in claim 12, wherein
at least one of the rollers is a motor driven drive roller.

24. The manufacturing machine as claimed in claim 12, wherein
the circuitry is configured to perform delay control to account for a time lag between detection of the diameter and crimping of the sheet.

25. The manufacturing machine as claimed in claim 12, wherein the parameter comprises at least one of:
a width of crimped portions in the width direction of the sheet,
a number of crimped portions in the width direction of the sheet, and
a position of crimped portions in a longitudinal direction and the width direction of the sheet.

26. A manufacturing method for a rod used in a flavor inhaler, the manufacturing method comprising:
feeding a sheet from a roll to a conveying path;
performing a crimping process on the sheet;
detecting a diameter of the roll from which the sheet is being fed;
controlling a parameter relating to the crimping process based on the detected diameter;
gathering the crimped sheet in a width direction to form a bundled rod;
wrapping the bundled rod with rolling paper to form a continuous rod; and
cutting the continuous rod into rods.

27. The manufacturing method as claimed in claim 26, wherein
controlling the parameter comprises controlling a crimping depth of the sheet.

28. The manufacturing method as claimed in claim 26, wherein
detecting the diameter comprises detecting the diameter without contact with the roll.

29. The manufacturing method as claimed in claim 26, further comprising:
acquiring data relating to a thickness of the sheet corresponding to the diameter, wherein
controlling the parameter comprises controlling the parameter based on the acquired thickness that corresponds to the detected diameter.

30. The manufacturing method as claimed in claim 26, wherein
feeding the sheet comprises feeding the sheet from the roll on which a sheet having a thickness of 100 μm or more has been wound.

31. A manufacturing machine for a rod used in a flavor inhaler comprising:
a roll;
guide rollers configured to guide a sheet from the roll;
feed rollers configured to feed the sheet along a conveying path;
a first roller having projecting ridges formed along a circumferential direction of an outer circumferential surface;
a second roller having recesses formed along a circumferential direction of an outer circumferential surface, the recesses configured to mesh with the ridges to form meshing portions with the sheet interposed therebetween;
a sensor configured to detect a diameter of the roll without contacting the roll;
circuitry configured to:
acquire, from memory, data relating to a thickness of the sheet corresponding to the detected diameter; and
control an inter-axial distance between a rotational axis of the first roller and a rotational axis of the second roller based on the acquired thickness to control a meshing depth of the meshing portions and thereby control a crimping depth of crimped portions formed in the sheet;
a liquid adding booth configured to spray a liquid additive onto the sheet;
a trumpet guide having a tubular shape with an inner circumferential surface that gradually decreases in diameter, the trumpet guide configured to gather the sheet into a rod shape;
a tong configured to further reduce a diameter of the gathered sheet to form a bundled rod;
a wrapper configured to wrap the bundled rod with rolling paper while reducing the diameter to form a continuous rod; and
a cutter configured to cut the continuous rod into rods.
